(19) United States
(12) Patent Application Publication
(10) Pub. No.: US 2012/0239416 A1
(43) Pub. Date: Sep. 20, 2012

(54) SOFTWARE-BASED LIFESTYLE MANAGEMENT TOOL

(76) Inventor: Marc Langva, Excelsior, MN (US)

(21) Appl. No.: 13/402,540

(22) Filed: Feb. 22, 2012

Related U.S. Application Data
(60) Provisional application No. 61/445,385, filed on Feb. 22, 2011.

(51) Int. Cl. G06Q 40/00; G06Q 50/22

(52) U.S. Cl. 705/2

(57) ABSTRACT

A lifestyle management tool may determine a first work optional date, wherein the first work optional date is a date in which a user's retirement income is greater than a user's expense. The tool may also receive past health characteristics of the user, current health current characteristics of the user, and future health characteristics of the user. The tool may further derive an estimated date of death of the user based on the received health characteristics of the user. The tool may also calculate the net present value of the user's income less expenses each year from the first work optional date until the estimated date of death. The tool may also determine a second work optional date, wherein the second work optional date is a date in which the net present value of the user's income moves from negative to positive.

### CROSS-REFERENCE TO RELATED PATENT DOCUMENTS

This patent application claims the benefit of priority, under 35 U.S.C. Section 119(e), to U.S. Provisional Patent Application Ser. No. 61/445,385, entitled “SOFTWARE-BASED LIFESTYLE MANAGEMENT TOOL,” filed on Feb. 22, 2011 (Attorney Docket No. 3064.001PRV), which is incorporated by reference in its entirety.

### TECHNICAL FIELD

This patent document pertains generally to user software tools, and more particularly, but not by way of limitation to a software-based lifestyle management tools.

### BACKGROUND

Various applications or web-based tools are available users to help with financial planning. For example, one application may allow a user to enter the user's current savings, an amount of savings each month, an expected rate-of-return, and an anticipated retirement date. The application may then calculate if the user will have enough money at the anticipated retirement date to comfortably retire.

### SUMMARY

A software or web-based system and method are disclosed to help an individual make life decisions such that one or more of the individual's time, money, and/or energy are used in an efficient manner. In an embodiment, the method includes, capturing a variety of end user inputs, running a series of calculations, and outputting one or more outputs based on the calculations. For example, the system may output different retirement dates (also referred to as a Work Optional Date or WOD) based on the options available to the individual. Other outputs may include money impacts and health impacts of a variety of decisions.

### BRIEF DESCRIPTION OF THE DRAWINGS

Some embodiments are illustrated by way of example and not limitation in the figures of the accompanying drawings in which:

FIG. 1 is a system diagram according to an embodiment of the present subject matter;

FIGS. 2-20 are user interfaces according to various embodiments of the present subject matter;

FIGS. 21A-21C are a tax sheet according to an embodiment of the present subject matter;

FIG. 22 is an output page, according to an embodiment of the present subject matter; and

FIG. 23 is a flowchart of a method according to embodiment of the present subject matter.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are illustrated in enough detail to enable those skilled in the art to practice the invention. The embodiments may be combined, other embodiments may be utilized, or structural, logical, and electrical changes may be made without departing from the scope of the present invention. References to “an”, “one”, or “various” embodiments in this disclosure are not necessarily to the same embodiment, and such references contemplate more than one embodiment. The following detailed description is, therefore, not to be taken in a limiting sense, and the scope of the present invention is defined by the appended claims and their legal equivalents.

People planning their future need help in answering a number of questions, such as, for example: what can I do to retire sooner, should I downsize my home, should I buy that car, should I help my children with college expenses, should we remodel our kitchen, what does that mean for my retirement date, what can I do to live longer, how can I use my time better, and how can I be more efficient? Current approaches use crude assumptions to tell an individual that if he/she continues on a current life path (whatever it might be), here is where he/she will end up. Unfortunately, existing programs do not go far enough or broad enough to explain this to an individual. There is no clear picture or vision of what the end result will be. In turn, there is also no clear picture of what they need to do today and in the coming years to achieve what they desire.

Some individuals tend to seek help in developing a life/financial plan that will assist them in reaching their personal and financial goals. Some individuals have increasingly relied upon hiring a financial professional. In general, most financial professionals use a variety of financial software or programs to calculate a client's retirement date as well as giving the individual advice on ways to achieve that retirement date. Professionals may be able to assist an individual with achieving or improving their retirement date, however, in general, most individuals fail to seek out the type of help they need from these professionals. In addition, any advice given to an individual by a professional is subjective based on the professional's life experiences. Furthermore, the help provided by these professionals is not real time.

For example, if the individual has a current retirement date of 2020 but is wondering about the ramifications of purchasing a new car, the professional cannot provide real time answers and data to the individual as he/she is standing at the car dealership ready to purchase a new vehicle. In various embodiments, the system described herein provides the real time impact of a user's decision. For example, the individual may input the cost/financing of the vehicle into a user interface of a mobile application and the application outputs the impact the purchase will have on the user's retirement date. In various embodiments, health and time impacts of the individual of a user are also calculated and presented to the individual.

In various embodiments, the system generates a retirement date (also referred to as a Work Optional Date or WOD). In an embodiment, a method includes capturing a variety of user inputs, running a range of calculations, and outputting a WOD to the user. In various embodiments, the system takes into account a user's initial inputs and determines a number of retirement dates for the user. Then, the last and most accurate retirement date is found and outputted to the user. This date is when the user could retire or be Work Optional. While the following system is described in the context of planning for retirement it may be used for other life planning such as planning for college funding, planning for a major purchase, etc.

In various embodiments, the system includes a variety of calculations with respect to a user's inputs. The calculations of the system are based upon financial and other input data provided by the user or gathered by the system. The output of the software is a variety of data that may be viewed on a display device, printed in a report format, or other presentation or display method, for the user. The output may include a retirement date (work optional date), a coaching report, a net worth statement, or an income sources report. These outputs may help the user decide what actions to take in the immediate, near, and far timeframes. While the various embodiments described below make reference to specific values for various items such as age and dollar amounts, other embodiments may use different values without departing from the scope of the invention.

In an embodiment, the coaching report provides the user with a customized output. The system determines what the individual could change/improve in the user's life to result in a more favorable retirement date. These coaching suggestions are decided by the system and included on the user's coaching report based on initial inputs by the user or decision system.

In an embodiment, the net worth statement provides the user with a report showing all assets and liabilities.

In an embodiment, the income sources report provides the user with a report showing all sources of current income as well as future income that will be used once the user is retired. This report may be in text and/or graphic format. The report gives the user a visual representation of the different sources of his/her income during the rest of his/her life. Additionally, the user may visually see fluctuations or large increases/decreases in the amount taken from investments.

When used herein, the term “individual” or “user” refers to the person who is the subject of the financial, time, or health calculations. The individual may be assisted by a professional. As such, the individual need not be the person who actually enters information into the system. The information may also be entered, for example, by one or more of a data entry operator, another program or software, computerized scanning methods, imported data, automatic entry into the system or a financial planning professional. Other ways to enter data may be employed without departing from the scope of the present subject matter.

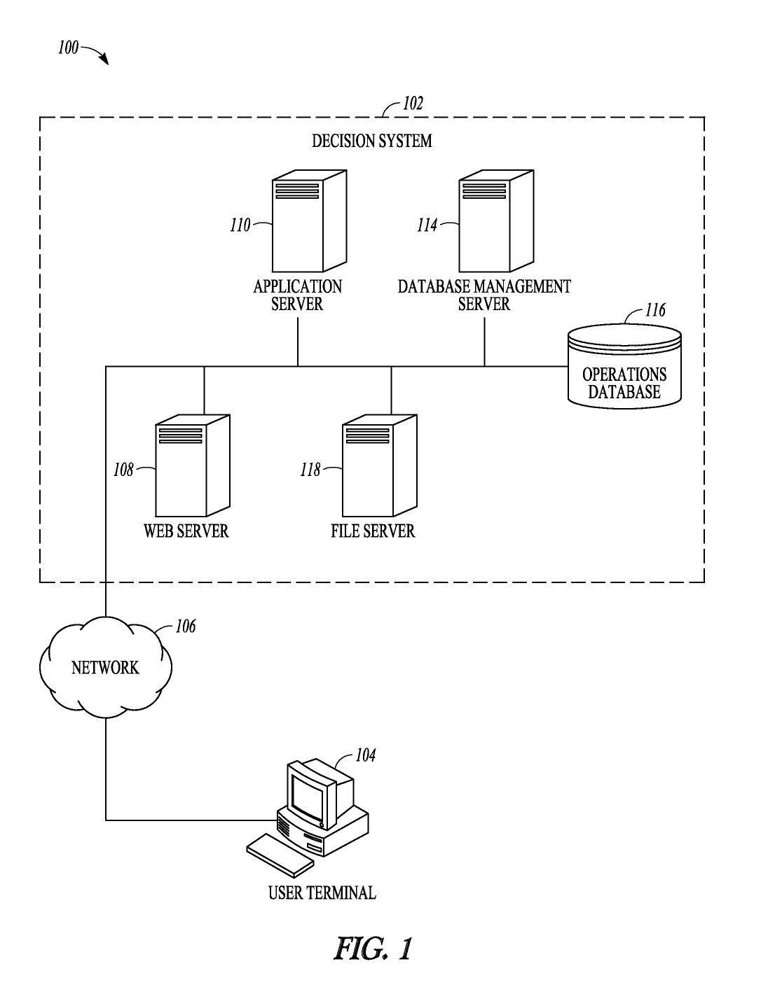

FIG. 1 is a schematic view of computer network system 100 according to various embodiments. Computer network system 100 includes decision system 102 and user terminal 104, communicatively coupled via network 106. In an embodiment, decision system 102 includes web server 108, application server 110, database management server 114, operations database 116, and file server 118. Decision system 102 may be implemented as a distributed system, for example one or more elements of decision system 102 may be located across a wide-area network from other elements of decision system 102. As another example, a server (e.g., web server 108, file server 118, or database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. Network 106 may include a single local area network (LAN) or wide-area network (WAN), or combinations of LAN's or WAN's, such as the Internet. Various devices coupled to network 106 may be coupled to network 106 via one or more wired or wireless connections.

Web server 108 may communicate with file server 118 to publish or serve files stored on file server 118. Web server 108 may also communicate or interface with application server 110 to enable web-based presentation of information. For example, application server 110 may consist of scripts, applications, or library files that provide primary or auxiliary functionality to web server 108 (e.g., multimedia, file transfer, or dynamic interface functions). In addition, application server 110 may also provide some or the entire interface for web server 108 to communicate with one or more of the other servers in decision system 102 (e.g., database management server 114). Web server 108, either alone or in conjunction with one or more other computers in decision system 102, may provide a user-interface. The user-interface may be implemented using a variety of programming languages or programming methods, including, but not limited to HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™). Other programming languages may be employed without departing from the scope of the present subject matter.

User terminal 104 may be a personal computer or mobile device. In an embodiment, user terminal 104 includes an application program to interface with decision system 102. The application program may be an application that runs natively on the user terminal (e.g., a downloaded application) or an application that runs over network 106. The application program may also be an internet browser that displays a user interface hosted by decision system 102. The application program may include commercial software, custom software, open source software, freeware, shareware, or other types of software packages. In an embodiment, the application program includes a thin client designed to provide query and data manipulation tools for a user of user terminal 104. The application program may interact with a server program hosted by, for example, application server 110. Additionally, the application program may interface with database management server 114.

Operations database 116 may be composed of one or more logical or physical databases. For example, operations database 116 may be viewed as a system of databases that when viewed as a compilation, represent an “operations database.” Sub-databases in such a configuration may include an health database and a financial database, and a goals database. Operations database 116 may be implemented as a relational database, a centralized database, a distributed database, an object oriented database, or a flat database in various embodiments.

During operation, data from multiple data sources is imported into operations database 116. Data sources may exist within an organization or exist at external source 120, such as a public record source or a private record source. The data may be imported and stored in the operations database on a scheduled basis, such as weekly, monthly, quarterly, or some other regular or periodic interval. Alternatively, the data may be imported on-demand.

Sources may include data sources associated with the organization providing decision system 102. For example, the organization may offer financial services such as investment accounts, credit accounts, and banking services. Data associated with a user of decision system 102 may be automatically imported into operations database 116. Another source may be the user himself/herself. External sources 120 may include transaction data, wealth data, health data, location data, etc., associated with the user that is stored in databases external to decision system 102. For example, the health records of the user may be accessed to gather medical data related to the user. In various embodiment, the data from the various sources is gathered in real time. For example, if a user has a credit card through the provider of decision system 102, purchase data using the credit card may automatically be imported into operations database 116.

In an embodiment, a device helps track information about a user. The device may also record the location of the user, for example when the user is in a certain proximity to various things or places. Suppose user Bill wears a watch (his proximity device) and similar devices are placed in various spots around Bill's home and work place. For example, Bill has one on his televisions to track how much time he watches TV, near his bed to track how much time he sleeps, on his computer to track how much time he spends surfing the internet, at work to track how much time he works, in his car to track how much time he spends commuting, in his bathroom to track how much time he spends getting ready each day (transition time), etc. The device may connect (e.g., wirelessly or through a wired connection) to the overall system to download and historically track how Bill spends his time.

To track exercise, a heat rate monitor may allow the system to download the calories Bill is burning, the amount of time Bill elevates his heart rate per day, and perhaps the amount of time he spends sleeping. Along with a wrist sensor, for instance, there may be other sensors tracking the amount of steps Bill takes each day or the amount of time they spend eating. The device may record Bill's time and energy, analyze the data, output the data in an understandable and organized format and make recommendations as to how Bill could improve his efficiency and health.

In an embodiment, one or more retirement dates are calculated for the user. In various embodiments, personal information of the user is inputted into the system (e.g., decision system 102). The information may be inputted by the user or be retrieving existing information already stored related to the user. This personal information may include, but is not limited to, tax information, net rental income, business income, lump sum income, social security income, pension income, and investment income.

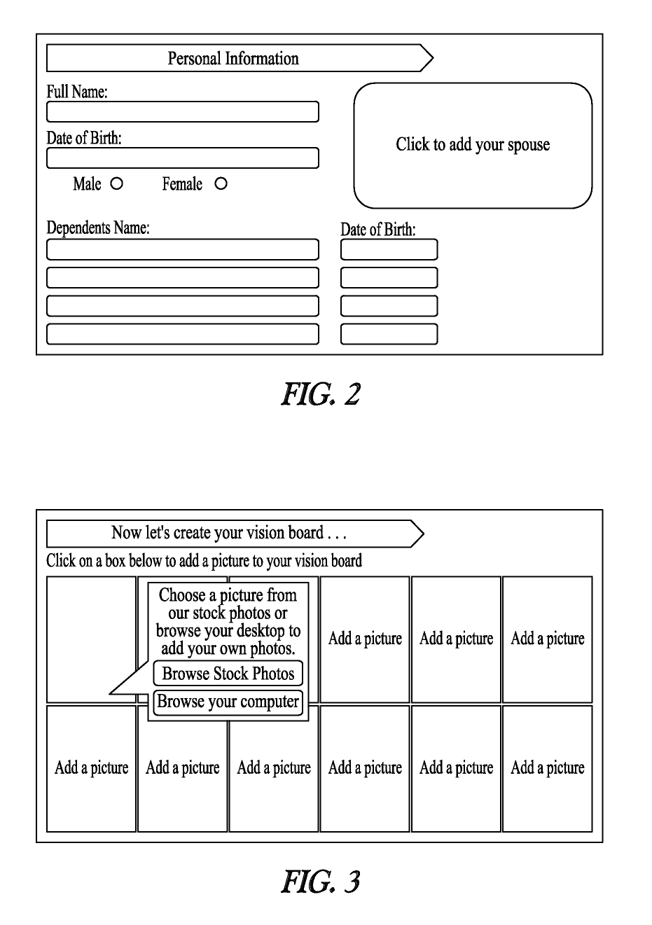

FIGS. 2-15 are example inputs interface that a user may use to input information about the user. The inputted information may entered using user terminal 104 through an application program and transmitted to decision system 104 over network 106. The information may be stored in one or more of the databases in operations database 116.

The user interfaces may be generated and outputted by executing instructions stored on a storage device (e.g., machine readable media) using one or more processors. In an embodiment, the machine-readable media is non-transitory. The executed instructions may configure the one or more processors to interact with one or more computer components (e.g., output devices, memory, input devices) to generate the user interfaces and display them on a display device. Further instructions may be stored on machine readable media which, when executed, cause one or more processors to perform the methods described herein. While the user interfaces are described with respect to a user entering information, the information may be entered by any person or automatically in various example embodiments. The following examples are provided to demonstrate the system, but are not an exhaustive or exclusive representation of the various user interfaces. Variations in user interfaces are possible and within the scope of the present subject matter.

FIG. 2 is a user interface for inputting a user's name, date of birth, (spouse's name and date of birth), dependent names and dates of birth according to an example embodiment. The user's (spouse's) age flows into the retirement calculator and is used to determine social security amounts, pension amounts, and the investment burn rate year over year. The amounts are then used to find the user's retirement date.

FIG. 3 is user interface for inputting visions (e.g., purchasing a home) or dreams in a visual format, according to an example embodiment. Visions may encourage the user to live a more deliberate, contemplative and financially savvy life. Visions and dreams may also be inputted textually as well.

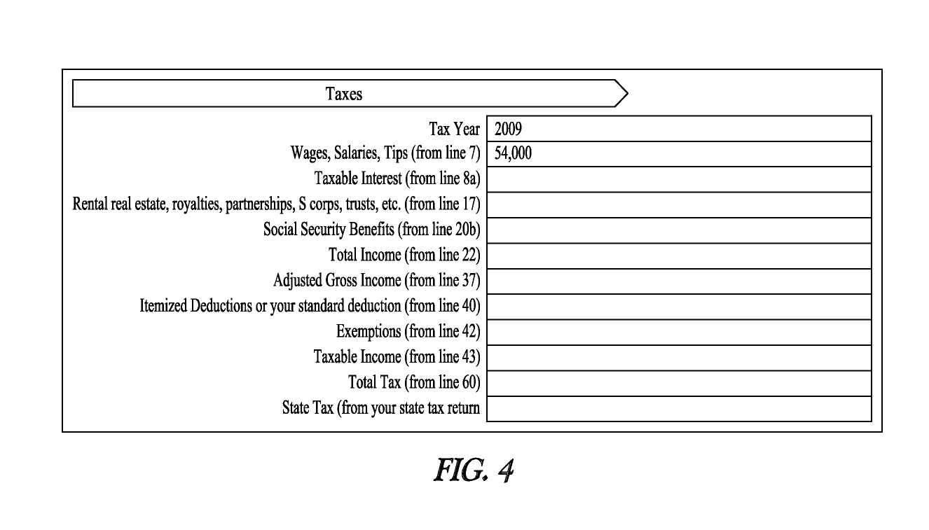

FIG. 4 is a user interface for inputting either the user's most significant tax information used for financial planning or all of the user's tax information line by line, according to an example embodiment. This tax information may come directly from the user's tax return or entered in by a user. In an embodiment, the row numbers and titles running down the first and second columns respectively are identical to the user's tax return. This interface may expand to allow the user to input past tax information and all tax information line by line. Key numbers including wages/salaries/tips and Adjusted Gross Income (AGI) are used to calculate the savings ratio and lifestyle of the user. The lifestyle and savings ratios are then projected year over year and used to determine a user's retirement date.

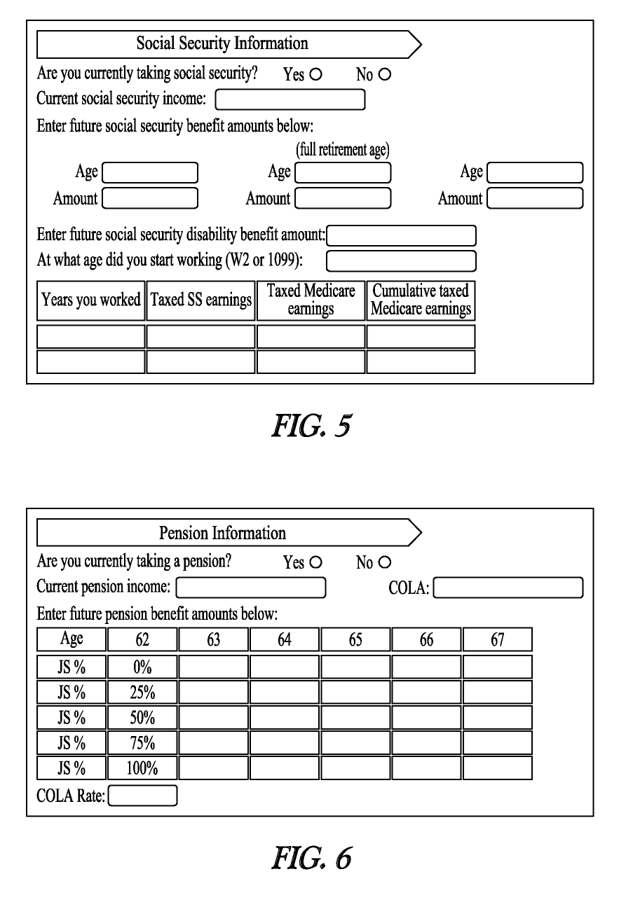

FIG. 5 is a user interface for inputting the user's social security information and earnings history, according to an example embodiment. The information needed to complete this user interface may come directly from the user's social security statement. If the user is already receiving social security, there is an option to check ‘yes’ and enter the current social security income. If the user is not receiving social security income, an option is presented to check no and enter three different data points. In an embodiment, the points are the estimated social security amounts are 62, full retirement age (66 or 67) and 70. However, the ages may be changed by the user if the user is past age 62. The user enters his or her social security benefit if he or she became disabled. Also, the user enters the age that he or she started working and paying into social security. Lastly, the user enters in social security and Medicare earnings history.

FIG. 6 is a user interface for inputting the user's pension options or pension history, according to an example embodiment. The information to complete this user interface may come from a detail pension benefits statement or from the pension benefits web site. If the user is already receiving pension income, he may enter the amount in the box titled current pension amount. If the pension has a cola, he may enter the rate in the box titled COLA. If the user is under age 62 he may check yes and enter their estimated pension amount at age 62. If the user is older than 62, the user enters in an estimated amount of their choosing and the corresponding age. The user then has the option to provide further details about his pension. In an embodiment, the user may enter up to 25 different amounts at various ages and survivorships. In an embodiment, the user interface is able to expand for user's that have more than one pension.

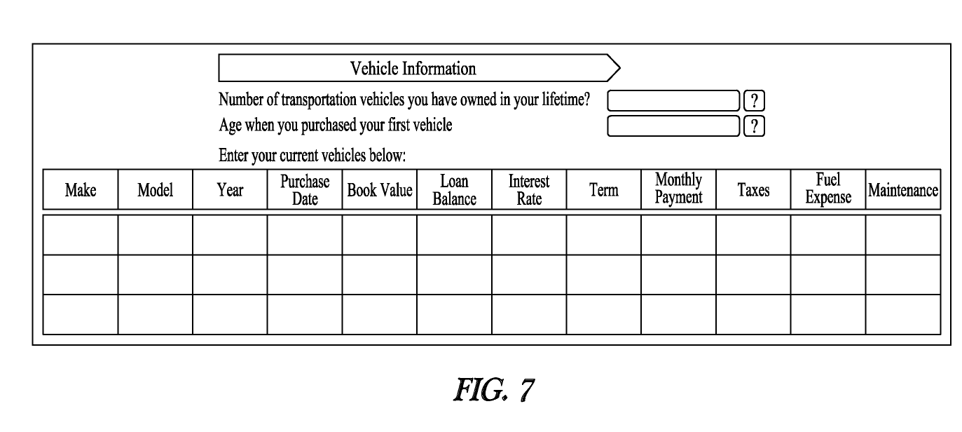

FIG. 7 is a user interface for inputting the number of transportation vehicles a user has owned in her lifetime, the average age of vehicles purchased, and the age the user was when she purchased her first vehicle, according to an example embodiment. This information is used estimate the amount of money spent on vehicles and the amount of money that could be saved by following recommendations of the system. The savings may be added to the investment to determine how many working years the user could save. The remaining input boxes allows the user to input details about the vehicle including, type, value, and loan information. The input information may flow to other parts of the system for use in various calculations such as the user's net worth calculation. In an embodiment, vehicle's owned by the user's spouse are also inputted.

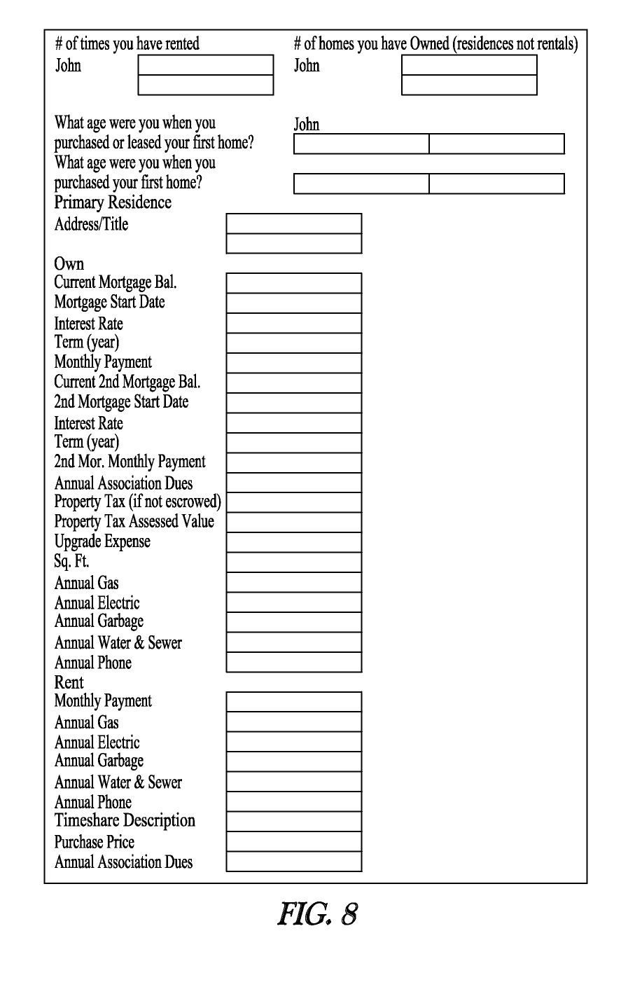

FIG. 8 is a user interface for inputting the number of times a user has rented, the number of times he has owned, the age he was when he rent/leased or purchased his first shelter, and the age he was when he purchased his first shelter, according to an example embodiment. The other inputs allow the user to give details of his current shelter. Residences, rentals, and timeshares may expand if the user has more than one shelter. Shelter input flows to both the statement of financial position to calculate the user's net worth and to calculate any additional cost or savings resulting from a shelter change.

FIG. 9 is a user interface for inputting information concerning investments of the user, according to an example embodiment. If the user has any paper assets, she inputs the type of account, a description of the account, who owns the account, if the investment is qualified, the market value of the account, annual additions to the account and any employer matches to the account. The inputs may include information on liquidity such as a description of the account, the value, and any additional savings. The user may also input her historical rates of return that may override a rate of return set by the system. If the user has real estate assets, she may give the type, a description, the value, net income, and loan information. For business assets, the user may input the type of business, a description, the value, and the net income. As for collectibles and hard assets, the user may give a description and the value. In various embodiments, investment classes may expand to cover as many investments as the user has. Investment contributions and employer matches are summed to find the user's annual savings amount. Annual savings along with the total value of paper assets, any net income from the investments and mortgage information are all used to calculate the user's retirement date.

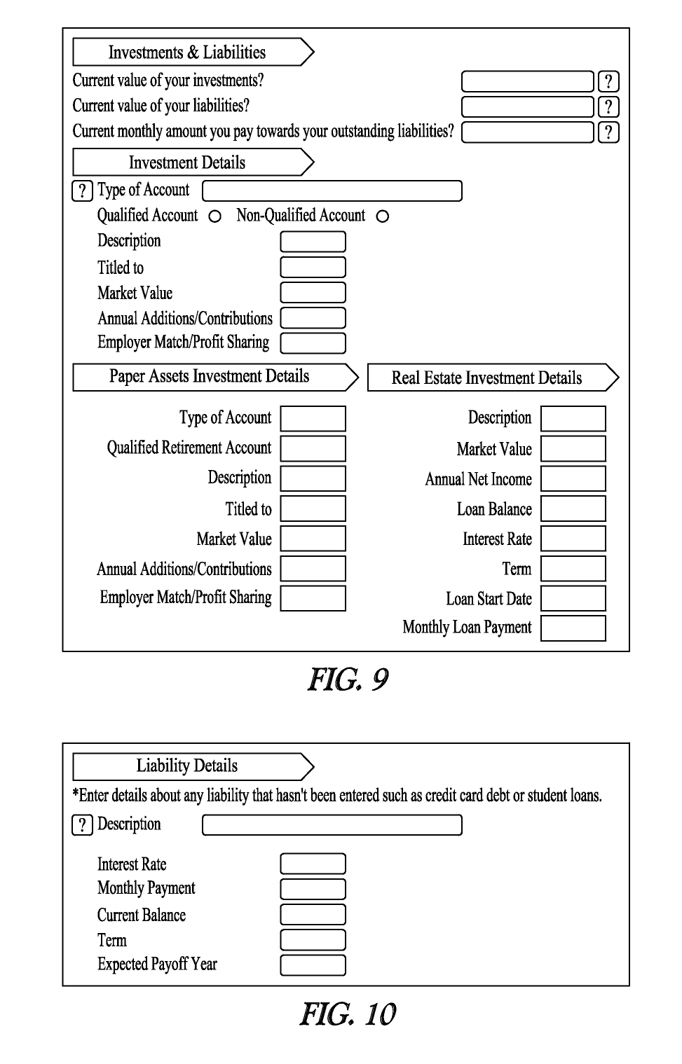

FIG. 10 is a user interface for inputting information about liabilities other than mortgages and car loans, according to an example embodiment. The user enters a description of the type of loan, the interest rate, the monthly payment, current loan balance, the term and the expected payoff year. The page is able to expand to cover all user liabilities.

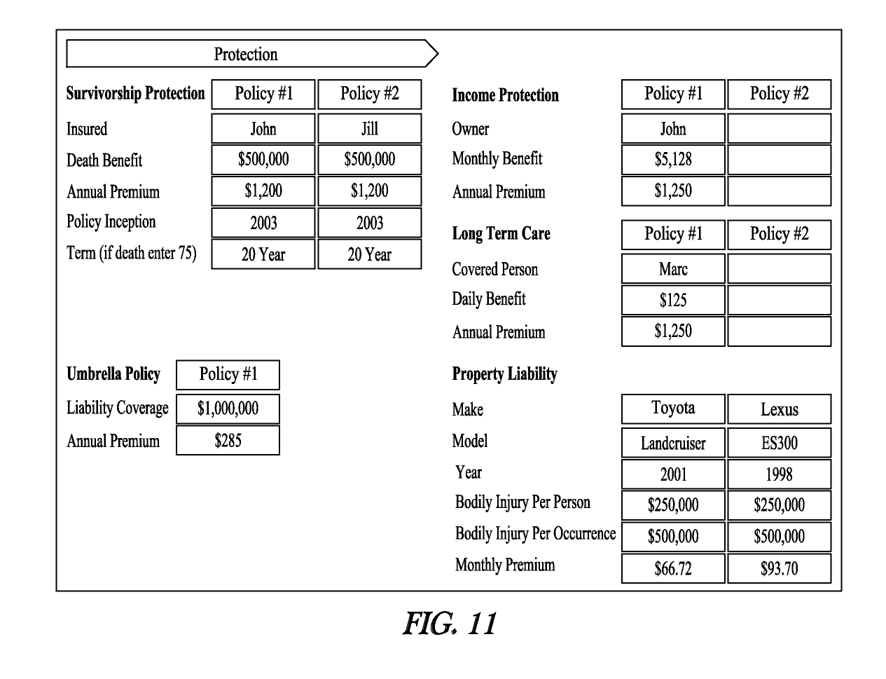

FIG. 11 is a user interface for inputting necessary information about protection, according to an example embodiment. Also, information regarding personal property, health/dental insurance, disability insurance (income protection), life insurance (survivorship protection), property/liability insurance, home/renters/association insurance, long term care insurance (family protection), and an umbrella policy may be entered.

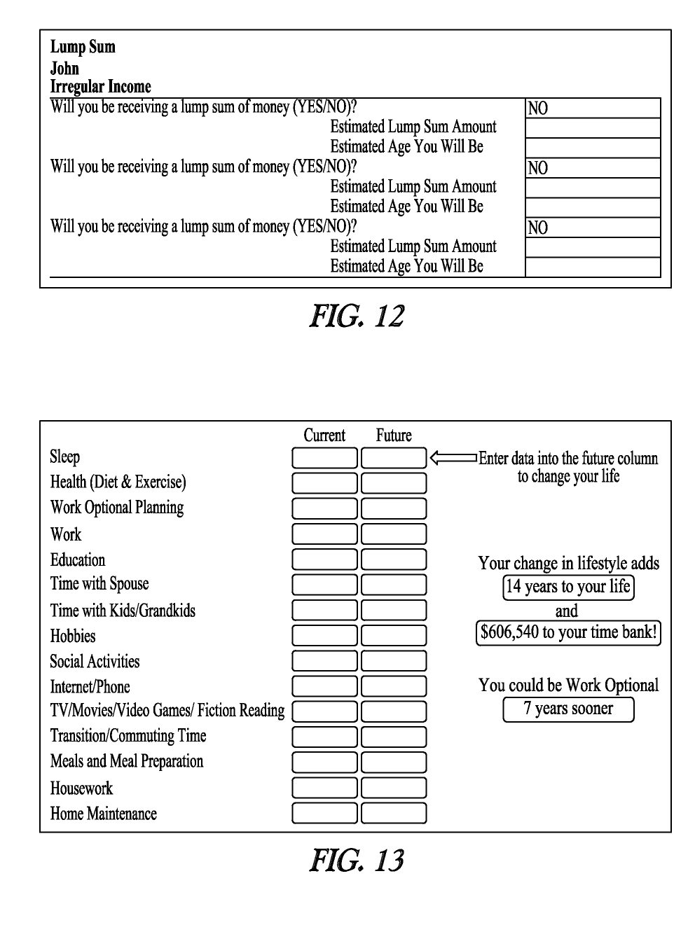

FIG. 12 is a user interface for inputting estimated lump sum amounts and the estimated age the user will be when he receives the amount. For example, the user may enter an estimated inheritance.

FIG. 13 is a user interface for inputting how the user spends her time. The options may be as follows: sleep, health (diet preparation and exercise-walking/biking), work optional/retirement planning, work, education (school, non-fiction reading, training, mentoring), spouse time (dates, eating together, talking together, sex), kids/grandkids time (playing, eating, reading homework, developing your children), hobbies/sports/shopping/fun, social activities (dinning out/events/church), internet/phone, television/movies/video games/non-fiction reading, transition/commuting, meals and meal preparation (dishes/grocery shopping, non-hobby/non-family), housework (cleaning, laundry, necessity shopping), maintenance (yard work, snow removal, auto maintenance). If desired, the user may click on a box to use the US national averages (e.g., the average time a US citizen spends doing these items). Additionally, the user may fill in each blank with an amount of time (e.g., 0.5 hours). When complete the column should add up to 24 hours. If the total does not equal 24 the interface may present a message to the user indicating she needs to change one or more of the amounts entered. Illustrated are two sets of input, actual and future. Both are represented in graphical form so the user can see where she spends her time and how she would like to. Also illustrated is the change the future habits will change their life in health, money, and retirement date.

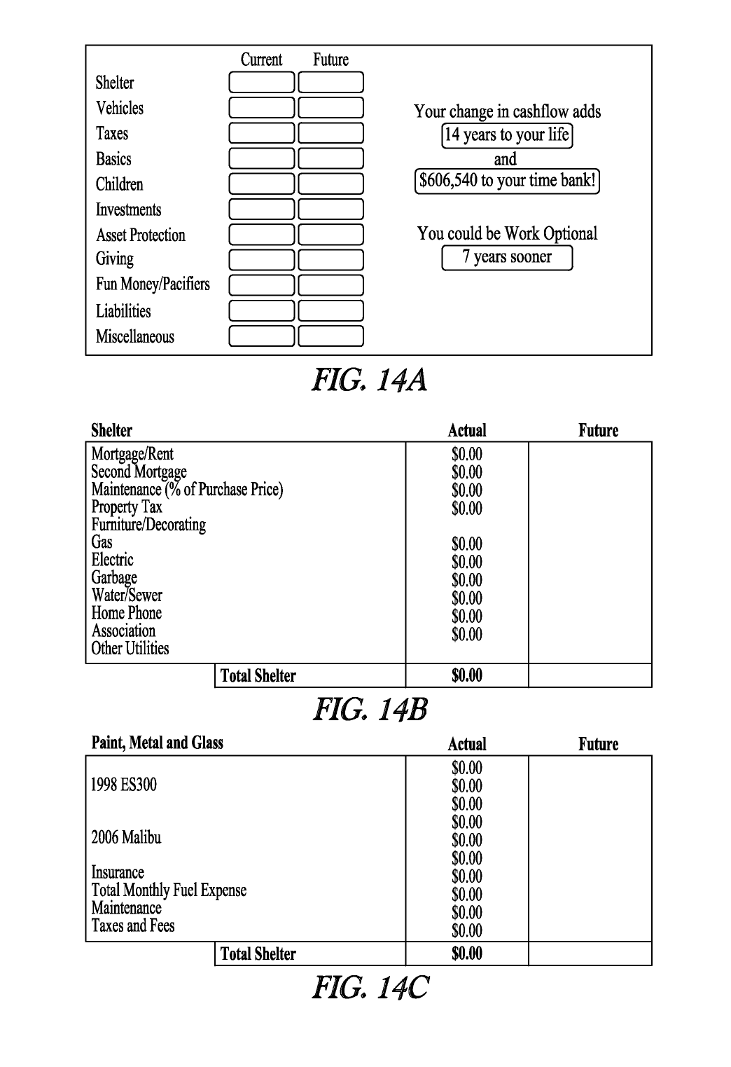

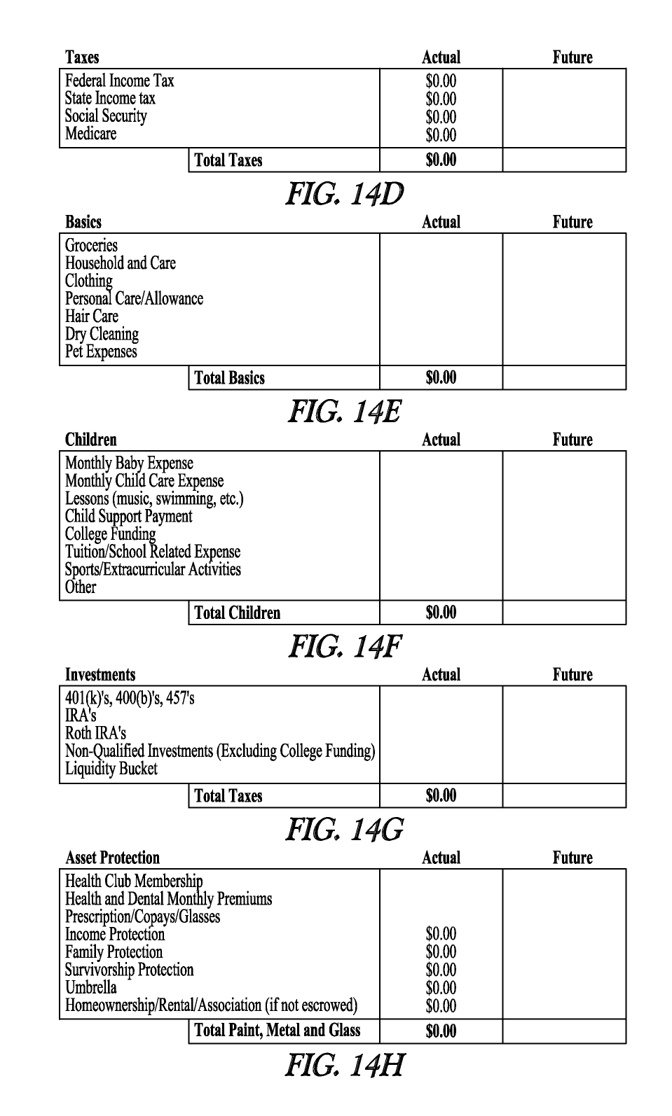

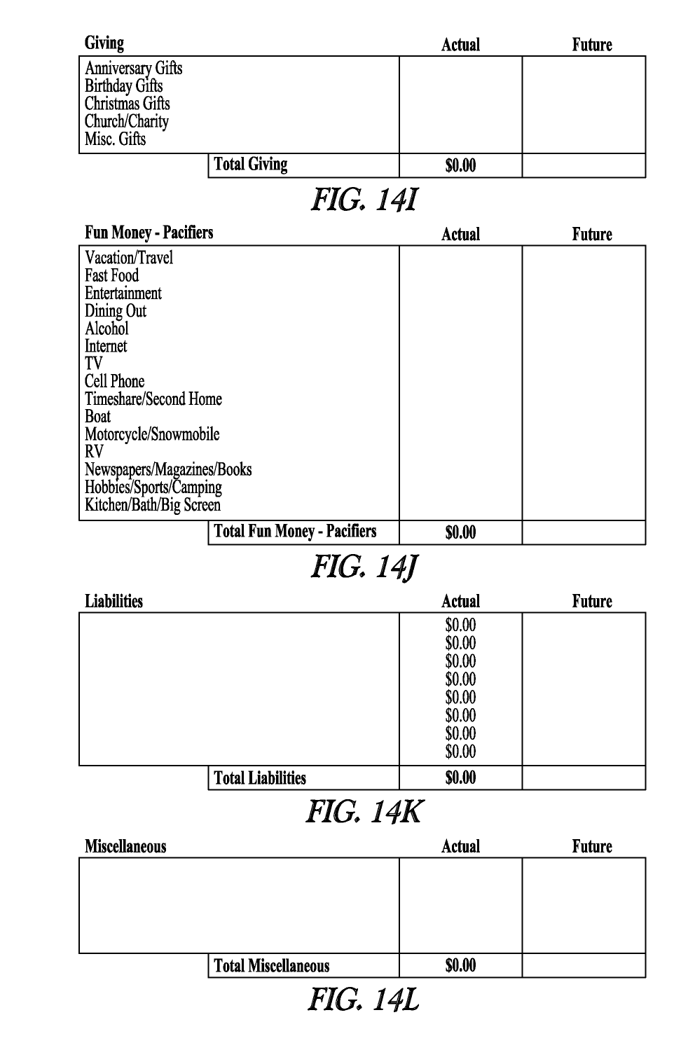

FIGS. 14A-14L are user interfaces for inputting and outputting cash flow information, according to an example embodiment. Some of the information may automatically be filled by information that has already been inputted by the user. The user may fill information that has not yet been received. In an embodiment, the main categories are as follows: income, shelter, vehicles, taxes, basics, children, investments, protection, giving, pacifiers, liabilities and miscellaneous. In an embodiment, the user interface may show the difference between income and expenses. The cash flow statement may allows the user to see where their money is going and where the easiest places to save money are. The user may also enter in future amounts and see the effect on the user's health, money, and retirement date.

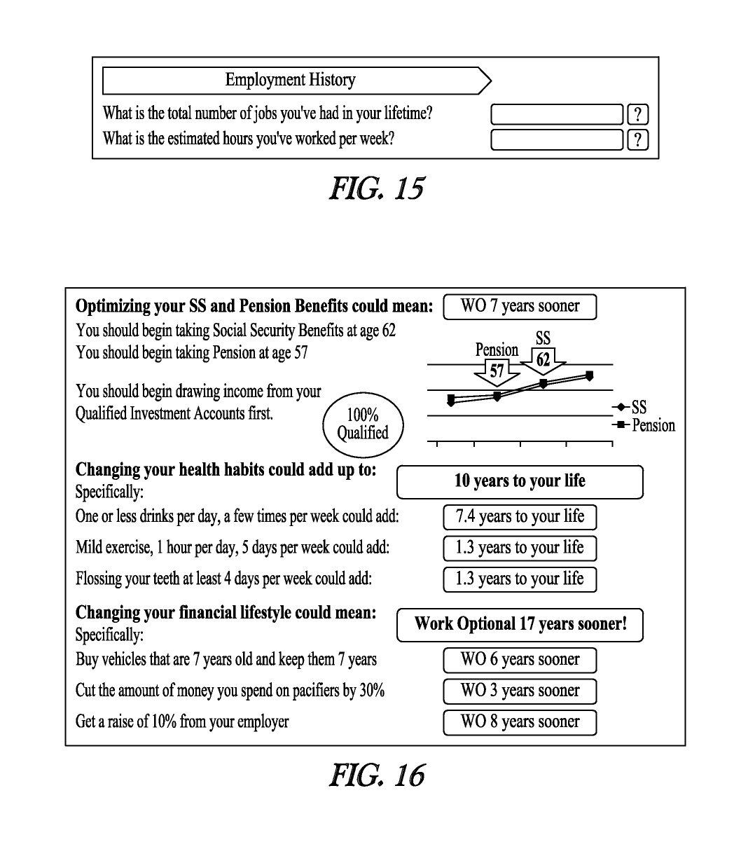

FIG. 15 is a user interface for inputting the total number of jobs the user has had and the average hours per week he has worked since the user's first job. The input may be used to calculate the user's work age and dollars per hour. The information may allow the user to see the effects of a raise or working more with respect to his retirement date

In an embodiment, the first retirement date calculated is the first year in which the user's retirement income is greater than the users expenses. Retirement income includes net rental and business income, lump sum income, social security income, pension income, and investment income. Investment income is a percentage of the user's total investments. In an embodiment, the percentage is based on a burn table. The label first, second, etc., as used in the context of retirements is for labeling purposes and may not always indicate an order in which the retirements dates are calculated.

The burn table gives a burn percentage which corresponds to the minimum age of the user at retirement. The pre-determined percent allows the users to withdraw a consistent inflation adjusted amount from his/her investments and not run out of money until they are around 108 years of age. The burn rate table is based on historical returns, user's longevity, user's current age, user's portfolio consistency, such as, for example the amount of investments the user has in qualified type accounts versus the amount of investments the user has in non-qualified type accounts which takes into account user's taxes.

In various embodiments, income sources are projected out year by year at various inflationary rates or at various rates or return. These assumptions may be controlled by either the user or the administrator of the decision system through a user interface that controls the decision system. Projections include investment return, inflation rate, assumed burn, social security inflation, income inflation, net rental/business inflation, savings inflation, pension cola (cost of living adjustment), and lump-sum inflation.

In various embodiment, investment amounts are not only projected at a certain rate of return but also the user's current savings amount, additional expenses and lifestyle changes factored in. For example, if the user decides to buy a sports car in two years, the Net Present Value (NPV) of the car will be subtracted from the user's current investment amount. Also, if the user receives a ten percent raise in pay, the additional income is added to his or her investments. To calculate the expenses year over year, the user inputs the user's current expenses or the amount of money the user will need when the user retires. The amount is inflated out less any mortgages that are paid off and any current monthly expenses that the user will not have when retired.

In an embodiment, a second retirement date is calculated as follows. Retirement income less expenses is found for each year beginning with the user's retirement date and ending when the user turns 85 year old. If the user's age is less than or equal to 62 at his or her retirement date, the social securities and pensions are taken at 62 and inflated appropriately. If the user is older than 62 at his or her first retirement date, social security and pensions are taken at their retirement age. Income less expenses are net present valued in the retirement year calculated by the first retirement date. The NPV is present valued in reverse subtracting the expenses and savings in each year until the present value is less than zero. The year the present value moves from negative to positive is the second work optional date.

In various embodiments, a third retirement date is calculated when the user is unable to retire before age 70 according to the first retirement date. In this third calculation, it is assumed the user takes social security at age 70 as there would be no benefit increases for waiting past age 70. The system takes the user's social security at age 70 and adds it to user's savings. The net present value (NPV) from age 70 to the user's second retirement date is used at retirement or WOD. The NPV is present valued in reverse subtracting the expenses and savings in each year until the present value is less than zero. The year the present value moves from negative to positive is the third retirement date.

In an embodiment, a fourth retirement date uses a longevity calculator to more accurately depict the user's actual longevity. The fourth retirement date takes the NPV of the user's income less expenses each year from the first retirement date until the user's death. Then, the death is estimated with a longevity calculator. In an embodiment, the longevity calculator default (the default may be used in absence of additional data from user) is based on the social security longevity table. When the user chooses to complete the longevity input fields, it allows a more accurate longevity estimate according to the user's behavior and family history. When dealing with a couple (e.g., a user consisting of two people, such as a married couple), after the first person dies the second person's expenses can drop. This drop in lifestyle is based on the age of the second person and follows a lifestyle table. The social security and pension income can drop as well.

The inputs in the longevity calculator affect both the user's income and expenses year over year which ultimately affects the NPV. The NPV is present valued in reverse subtracting the expenses and savings in each year until the present value is less than zero. The year said present value moves from negative to positive is the fourth retirement date.

In various embodiments, the longevity calculator is composed of two main components (longevity and time) which may function as independent units but are also integrated into a complex multi-component system used to find the user's retirement date. To utilize the longevity calculator, the user answers a series of questions on exercise, diet, stress, hygiene, driving, drug use, disease, education, mental health and family history for the present time (the last three years), the past (everything prior to the last three years), and the future (how they expect to live going forward). The answers may come from the user directly via an application program or the answers may be obtained from one or more datastores (e.g., a medical database or operations database 116). In an embodiment, the answers may be updated in real time. For example, if the user pays for a gym membership with a credit card provided by decision system 102, exercise information may be updated. Each of the answers provided may correspond to a table with adjustment values. The adjustment values may be absolute or relative to an average. For example, if a user indicates he exercises one hour more a week than the average, the adjustment value may correspond to a two-year increase in estimated longevity. In various embodiments, non-linear adjustment values may be used. For example, a two hour increase, relative to the average, may correspond to a three-year increase in estimated longevity.

In an embodiment, there are three separate calculators running three different sets of data, one each for the past longevity, present longevity, and future longevity. Each calculator is weighted (e.g., 25% past, 25% present and 50% future, other weighting percentage may be used). In an embodiment, the future is more heavily weighted than the other two categories because the effects on many bad habits can be reversed. For example, if a user is overweight due to a poor diet and lack of exercise, the user's heart is under a lot of strain. It is difficult for a heart to pump blood to so much extra tissue. If the user decides to practice better behavior and loses the weight, there might be residual damage to the arteries, but for the most part, the heart is free from all that stress and the user can live a healthy life.

In an embodiment, the output of the longevity calculation is weighted based on the user's age. Each answer in the longevity calculator has a corresponding yearly value that can be negative or positive. The values are multiplied by the following ratio (expression):

(100−User's Age)/100

The values are then summed and added to the user's expected longevity based on U.S. Social Security tables.

The reason for weighting based on age may be explained with an example. A male age 38 has a life expectancy of 77.44 years according to social security longevity tables. After he takes the calculator he gets a raw score of −5 years. However, his life expectancy is not 72.44 when weighting by age. The negative five years is multiplied by 62/100 because he has already survived for 38 years.

A more extreme example would be a male age 90 who has a social security longevity of 98. He may obtain a raw score of −10 from the longevity calculator, but obviously his longevity is not 88 years old. Even though he may have smoked, drank, had high blood pressure and a poor family history the man has survived to age 90. The weighed calculation would be:

((100−90)/100 or 0.1)

Therefore, the man's longevity would be 97. He still is expected to die before his peers but not by as much.

The approximate death date found by the longevity calculator may be used in a variety of applications beyond determining a retirement date. For example, one could use the calculator to determine the optimal time to take social security and or pensions if applicable. The second component of the longevity calculator provides a method for sorting and displaying how an individual spends his or her time. This method is described in further detail in subsequent portions of this document.

In various embodiments, a fifth retirement date is calculated using the user's optimal social security and pension amounts. The method of calculating the fifth retirement date is similar to the method of calculating the fourth retirement date. However, instead of using the social security and pensions at the user's age 62 or at the user's retirement age, the user's social security and pensions are taken at their optimal (best) times for that particular user.

In an embodiment a tool is used to calculate the best time to take social security. The user begins by inputting three points (coordinates). In an embodiment, the three points are the amount of the user's social security at 62, at full retirement age (66 or 67) and at 70 years of age. Although, the ages are dynamic for clients who are past age 62. A third order polynomial trend line equation using a linear regression (e.g., the Linest function in Excel) is calculated and used to extrapolate the points between the endpoints. Any points outside of the three initial inputs are extrapolated at a certain percent controlled by an administrator of decision system 102. All social security amounts are inflated year over year until the estimated death of the user, as determined by the longevity calculator. These values are net-present-valued and compared to determine the highest net present value.

In various embodiments involves couples, after the first person dies the spouse gets the greater of the two social security amounts. There are a total of 81 different combinations in which a couple can take social security between age 62 and 70. For example, the husband could take social security at age 64 and the wife could take social security at age 62, or the husband could take social security at age 70 and the wife could take social security at age 65. Each of the 81 possibilities is net present valued taking each person's estimated death into account. Therefore the income stream starts at the designated ages, the minimum drops off at the first person's expected death and the remaining social security income drops off at the second person's death. The optimal social security option is the combination with the greatest net present value.

In an embodiment, a tool is used to calculate the optimal time in which the user or couple should take their pensions. The user begins by inputting pension amounts at different ages and at different survivorship percentages. Points at two ages are sufficient but more points allow for better accuracy. In an embodiment, it is recommended that one of the ages used is the earliest the user would retire and another age used is the latest the user expects to retire. (Polynomial trend lines are very accurate for points inside the boundary but on the outside the system extrapolates using a less accurate method such as a linear trend line.) The system may provide joint survivor options of 0%, 25%, 50%, 100% and a dynamic option such as 67% or 75%. If the user fills out all five ages and all five joint survivor options there will be a total of 25 inputs. Other percentages may be used without departing from the scope of the present subject matter.

Regardless of the number on inputs, a fifth order polynomial trend line equation using a linear regression (e.g., the Linest function in excel) is found and used to extrapolate the points between the endpoints. The ages between the minimum and maximum pension ages inputted by the user are inflated out year over year at each joint survivor option available. If the pension is 0% joint survivor, the amount is inflated out until the estimated death of the pension owner. If 100% joint survivor, the amount is inflated out until the estimated death of the last survivor. If 50% joint survivor, the amount is inflated out until the death of the owner and then 50% of the amount is inflated out until the death of the spouse. The options are net present valued with the optimal option having the highest net present value.

In various embodiments, the worst social security and pension options are also found. These options have the lowest net present value. Both the optimal social security and pension options and the worst social security and pension options may be used to calculate two different retirement dates. The worst case date is subtracted from the optimal date and may be presented to the user to show the importance of social security and pension decisions.

In various embodiments, the decision system analyzes financial and personal input in order to output financial and personal advice. Some of the tools available to user are discussed below.

In an embodiment, a second component of the longevity calculator provides a method for sorting and displaying how a user spends his or her time. The system not only gives an output of how a user spends time, but also coaches the user on how to spend time more wisely with the goal of an earlier retirement. In an embodiment, the decision system groups activities into one of four categories.

In an embodiment, the first category includes activity that furthers a user's ability to retire earlier. This category may include healthy living, retirement planning, work, education and time with the user's spouse. One who plans for retirement generally saves more, and spends less. If one is spending more time working, not only are they making more money for retirement but they are spending less because they no longer have as much time to spend money. Higher education can lead to higher paying job opportunities. Finally, overlooking one's spouse can lead to divorce, devastating the financial future and retirement goals of both parties. For the reasons given above, these categories may have a major impact on one's retirement.

In an embodiment, the second category includes events that people look forward too. The category may include spending time with kids and grandkids, hobbies/sports/shopping/fun, social activities, internet/phone, and TV/movies/video games/non-fiction reading.

In an embodiment, the third category may include time that is neither fun nor helpful for early retirement. The category may include transition/commuting time, meals and meal preparation (dishes/grocery shopping) non-hobby/non-family, housework (cleaning, laundry, necessity shopping) non-hobby, and maintenance (yard work, painting, auto maintenance) non-hobby.

In an embodiment, the last category is sleep. A healthy person should be getting six to eight hours of sleep a night.

In an embodiment, the user's input (which can be a simple input or a more detailed input as decided by the user) allows the system to offer coaching advice to assist user in achieving an earlier retirement, such as, for example, decreasing the time an individual spends watching TV, surfing the internet, talking on the phone, and transition time (for example, the time it takes individual to shower, get ready and drive to work) by thirty percent, and instead if the individual spends that time working, could allow the individual to retire sooner.

In an embodiment, decision system 102 provides a life insurance tool for calculating how much life insurance a person might need in the event of an early death. In an embodiment, the system assumes death at 62 for each spouse. Rather than getting the maximum optimal social security, the surviving spouse receives the maximum social security benefit between the two of them at 62. Also, the pensions received by the surviving spouse are the optimal pensions based on the couples estimated longevity as described previously. For example, if the husband was estimated to live ten years longer than the wife, his optimal pension would be 0% joint survivor. The system then assumes that the husband will die at age 62 and in this case, the wife will not get anything from her husband's pension. The adjusted income is projected year over year and subtracted from expense projections year over year. The net present value of the expense overage from retirement to the surviving spouse's death is the amount of insurance the surviving spouse would need to live an equivalent lifestyle. The current net present value of the projected investment value at the death of the surviving spouse is found to determine if the investments are enough to cover the insurance needed. The output for the user gives the amount of life insurance needed beyond what the investments could cover to ensure that the surviving spouse keeps his or her lifestyle. A test is run for each spouse to make certain that if either one were to pass away early, the other would be financially secure.

In an embodiment, a fourth component is a tool for calculating the ratio of qualified to non-qualified investment income with the goal of minimizing the user's tax liability. First, the user's annual expenses are determined and inflated out year over year. Expense projections account for details such as mortgage payoffs, etc. Income sources other than investment income are determined and inflated out in the same way expenses are. Expenses less income is calculated year over year to determine how much money if any is needed from one's investments. Investment income is used to fill in the gap between other income and expenses. The system calculates needed investment income for every year beginning with the user's estimated retirement date and ending at age 70. Over age 70, the value of investment income is either the investment income needed as before or the required minimum distribution, whichever is greater.

In an embodiment, the investment income may come from two different sources, qualified or non-qualified investments. The system may assume that tax has been paid on the non-qualified investments and therefore the user may withdraw non-qualified investments tax free. Qualified investment distributions are completely taxable because no tax has ever been paid on that money. Also, the qualified investments are differentiated by ownership between the husband and wife, if applicable. Eleven simulations are run using differing ratios of qualified and non-qualified investments to cover the investment amount needed for each year. The first ratio is 100% qualified and 0% non-qualified, then 90% qualified and 0% non-qualified all the way to 0% qualified and 100% non-qualified. Each of the ten simulations flow into a proprietary tax calculator that projects the tax liability based on the given simulation. In various embodiments, different numbers of simulations are run with different ratio granularities.

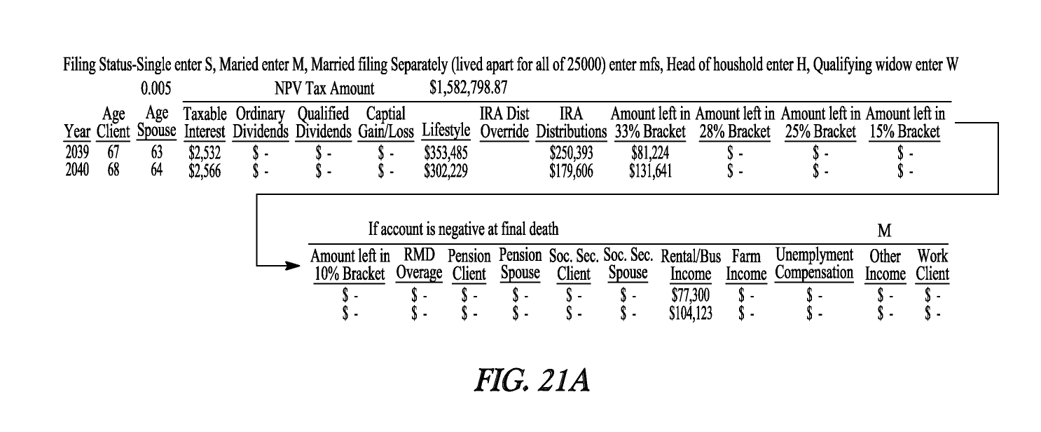

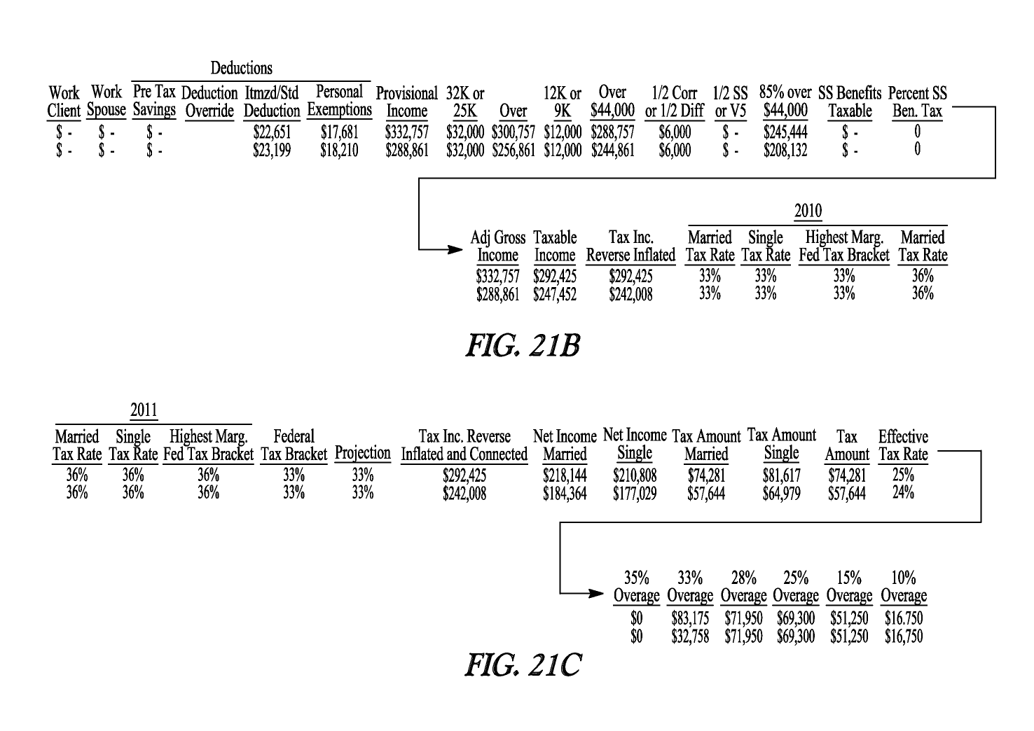

In an embodiment, FIGS. 21A-21C are a tax sheet (also referred to a tax calculator) that has been separated for readability. The tax sheet begins on FIG. 21A with two columns that project taxable interest and ordinary dividends year over year from non-qualified investment. The return may be changed by a system administrator or the user. In the following column the user is able to insert any expected future gains or losses. Next, the qualified distributions are projected based on one of the eleven simulations. These projections may be manually overridden. The subsequent columns give the amount of money remaining in each tax bracket.

In an embodiment, the system is designed so that once the user finds his or her optimal tax sheet; he or she may use the manual override for the qualified investments to minimize the tax liability even further. This may be done by filling up the amount remaining in a given tax bracket. Therefore, the money remaining in each tax bracket is next to the qualified investment override. The following column shows the Required Minimum Distribution (RMD) overage year over year. If all of the years read zero, the user may not have to worry about the tax consequences of RMD. Pension income, social security income, rental/business income, farm income, unemployment compensation, other income, work income, pretax savings, itemized/standard deductions and personal exemptions are listed year over year in the next thirteen columns respectively. Itemized deductions may be manually overridden year by year to fine tune one's tax liability even further.

In an embodiment, provisional income is calculated by summing taxable interest, ordinary dividends, capital gain/loss, qualified distributions, pension income, rental/business income, farm income, unemployment compensation, other income, work income and half of social security income less pre-tax savings. If the user is single, $25,000 is subtracted from provisional income, for couples it is $32,000. If the calculation is less than 0, none of the user's social security income is taxable. If the calculation is greater than zero, $9,000 for singles and $12,000 for couples is then subtracted from the remainder. If the new remainder is over 0, the following column takes half of $9,000 for singles or half of $12,000 for couples. If the new remainder is 0 or less, half of the first remainder is taken. For explanation purposes call this new amount A. The next column is the smaller of amount A or half the user's social security. Call this new amount B. The next column takes 85% of the second remainder or 85% of income over $34,000 for singles and $44,000 for couples. Call this amount C. Taxable social security benefits are the smaller of amount B+C or 85% of social security income. The following column finds the user's adjusted gross income which is the sum of taxable interest, ordinary dividends, capital gains/loss, qualified distributions, pension income, rental/business income, farm income, unemployment compensation, other income, work income, and taxable social security less pre-tax savings. Taxable income is AGI less deductions and exemptions. Rather than inflate the tax brackets, the system reverse inflates the taxable income. Also, the first estimated death of the couple is accounted for and the appropriate adjustments are made to account for a single instead of a couple. The final outputs find the user's marginal tax rate, tax amount, effective tax rate and the amounts in each tax bracket. It is understood that the numbers used in the above embodiment are exemplary in nature and may change for different circumstances. The embodiments provided are intended to demonstrate the present subject matter and not in a limited, exhaustive or exclusive sense.

Each simulation flows into a separate tax sheet. Therefore, the taxable interest, ordinary dividends and qualified distributions columns differ for each of the eleven cases. For example, 100% qualified and 0% non-qualified will have higher taxable interest and ordinary dividends because the simulation is letting the non-qualified investment accounts grow. Also, the qualified distributions will be greater earlier. However, after age 70 the qualified distribution or required minimum distribution could be a lot less because the qualified investments have been shrunk more, compared to other simulations. The net present value of the tax amounts for each year until the last user's death is found for each of the eleven simulations. The simulation with the lowest net present value is optimal because it has the lowest overall tax liability. The user can go to the tax sheet running the optimal simulation and adjust the distribution year by year based on their itemized deductions for that year to further optimize their tax liability.

In an embodiment, a fifth component is a tool for projecting the year in which the user's investments will go to zero and the value of the user's investments at their estimated death date. The investments are projected with a rate of return that is controlled by the system administrator. Once the user retires, distributions are calculated using the burn table. The first output of the system gives the year and ages of the users when the users' investments go to zero. The second output uses the estimated longevity dates from the longevity calculator and searches for the investment amount at the survivor's death if a couple, or user's death if single.

In an embodiment, a sixth component is a tool for projecting the total net worth of the user(s) at death. This tool may help one to decide if estate planning is needed to avoid or minimize estate taxes. In an embodiment, there are six pieces of information used in the calculation: shelter, paper assets, rentals/business assets, collectables, hard assets and personal property/other assets. The current value of each asset class is future valued to the death of the user at an inflation adjusted rate controlled by the system administrator and then summed with the exception of the personal property/other assets category. This personal property/other assets category may include vehicles, toys, clothes, furniture, etc., and is set at a default amount for all users. However, it can be changed by either the system administrator or the user.

In an embodiment, a seventh component is a tool for advising the user on how he or she might be able to improve their health and increase their longevity. Several recommendations may be given on various health topics, such as, for example, exercise, drinking alcohol and flossing with the corresponding longevity benefits related to each topic. In an embodiment, if no longevity benefit accompanies a certain recommendation or if the user's life expectancy is already age 100, the recommendation would not appear. The longevity benefit may be calculated using the longevity calculator discussed previously.

In an embodiment, an eighth component is a tool that offers financial coaching recommendations and the corresponding financial benefits in terms of a user's retirement date. Recommendations such as, for example, the user should buy vehicles that are seven years old and keep them for seven years, the user should cut the amount of money spent on pacifiers (e.g., vacations/travel, entertainment, fast food, dining out, alcohol, internet) by 30%, the user should get a 10% raise in pay, and the user should cut television time, internet-phone time and transition time by 30% and replace that time with work. These financial coaching suggestions may act as inputs in the retirement date calculations. Each potential change offers additional monthly savings which may be added to users long term investments for retirement and in term affect his or her retirement date. The calculations for several areas of savings are further explained below.

In an embodiment, the user inputs their current age, the average age of his or her vehicles when purchased, the number of vehicles he or she has owned throughout their lifetime and the year he or she bought their first vehicle (e.g., using user terminal 104). This information may allow the system to calculate an average number of years per vehicle using the following equation:

(Current Age−Age at first vehicle purchase)/Total Number of vehicles owned

In an embodiment, a depreciation schedule for vehicles gives the age of the vehicle in years and the corresponding average price. Using the depreciation table one can calculate the user's average purchase price for a vehicle from the user's average vehicle age when purchased. Also, one can calculate the user's average sold price for their vehicles. The system searches for the average age when purchased plus the average years per vehicle.

For example, suppose a user buys vehicles that are two years old on average and has a calculated output of five years per vehicle. This means that the user sells his or her vehicle when it is seven years old on average. The depreciation table has US average vehicle prices based on the age of the vehicle. A new vehicle in the US cost $28,400 on average. For this example, a vehicle that is two years old costs $18,881 and a vehicle that is seven years old costs $6,805. The total price of the user's vehicle in our example is $12,076 because it was bought when it was two years old at a cost of $18,881 and sold when it was seven years old at a cost of $6,805. Since the user in this example purchases a new vehicle every five years, the price of this vehicle is $2,415 per year ($12,076/5 years=$2,415).

In an embodiment, calculating the vehicle's insurance per year is similar to calculating vehicle cost per year. An insurance table corresponding to the vehicle's age is used. In an example, the user purchases a vehicle that is two years old. In his second year of ownership the vehicle is three years old, in his third year of ownership the vehicle is four years old, in his fourth year of ownership the vehicle is five years old, in his fifth year of ownership said vehicle is six years old, then the user sells his seven year old vehicle. When the user purchases a new vehicle that is two years old the schedule starts again.

The average vehicle insurance amounts corresponding to those five years is summed and divided by five (years/vehicle) to obtain the insurance expense per year. The tax on transfer expense is a certain percentage of the purchase price. In an embodiment, the percent is controlled by the user. The tax amount is also divided by five (years/vehicle) to obtain the tax expense per year. The last expense is a time value expense. The system assumes that it takes 40 hours to find and purchase a vehicle. For our example, the user buys a car every five years which means that he or she spends eight hours a year (on average) looking for and purchasing vehicles. Eight hours is then multiplied by the users wage in dollars per hour that was inputted by the user in the user interface.

By making a recommended change to purchasing vehicles that are seven years old cars and keeping them for seven years, money is saved in all of the previously mentioned categories. Overall, the purchase price is significantly lower, the collision insurance is lower because the car is not worth as much, the taxes on transfer are lower and the time spent looking for a vehicle is lower because it is done every seven years versus every five years. The actual price of the car per year, insurance per year, tax on transfer per year, and time value per year are summed less the recommended expense. The savings per year flows into the long term investments in each year which can result in an earlier retirement date which may be presented to the user.

In an embodiment, the second recommendation is to minimize pacifiers by 30%. Pacifiers may include expenses such as vacations/travel, entertainment, fast food, dining out, alcohol, internet, television, cell phone, timeshare/second home, boat, motorcycle/snowmobile, RV, newspapers/magazines/books, hobbies/sports/camps, kitchen upgrades/updates, bathroom upgrades/updates, or other large purchases such as, for example, big screen televisions, etc. In an embodiment, a complete cash flow statement is a module of the user interface, and pacifiers are included in the cash flow statement. The system takes the savings (30% of the pacifier amount from the cash flow statement) and adds it to the long term investments in each year which can result in an earlier retirement date.

In an embodiment, the third recommendation is to get a 10% raise in pay. The system takes ten percent of the user's current dollars per hour and multiplies that amount by hours per year. That yearly savings is added to the long term investments in each year which can result in an earlier retirement date.

In an embodiment, the fourth recommendation is to cut back on television, internet-phone, and transition time and work instead. The extra annual time spent working is multiplied by the user's dollars per hour and the extra money is added to investments each year. In this way, the “financial coaching tool” is able to output the number of working years the user can avoid by following the four financial coaching recommendations listed above.

In an embodiment, a decision tool allows the user to input details about any possible future decisions and receive the potential financial, health, and time impacts of the decision. The impacts may be assessed using one or more of the tools discussed herein.

In various embodiments, details of a decision a visual representation of each decision (as shown in a vision/dream board of the application program), the estimated cost (either as a lump sum or an amount per year) of each decision if applicable, and the start year and end year, wherein each decision has a direct effect in either cost or behavior, are displayed to the user.

The costs of all decisions for each designated year may be calculated using the NPV and subtracted from the user's investments. If the user's investments are less than the NPV, the NPV is found for the following year and subtracted from the users projected investment value in that year. If the investment amount is still less than said NPV, the following year is used and so on. If the investments are never enough then, depending on the output from the referenced calculation, the user will know the effect of their decision in terms of their retirement date. The potential decisions entered by the user in the user interface may directly affect the user's underlying data and ultimately cause the user's expected retirement date to change.

In an embodiment, the system outputs the cost of a decision in working years rather than a dollar amount. Additionally, the system may transform the cost of a decision from a monetary value into a time value. The user may see the impact of his or her decisions in real time and act accordingly by prioritizing, eliminating, or changing their vision/dream board. For example, the user might desire a certain type of sports car, but might not understand the true cost. Once the details of the sports car are entered into the vision board of the user interface and the user learns that the car may delay his or her retirement by three years the user may decide to eliminate that dream from his or her life plan.

In an embodiment, a personal lifestyle tool allows the user to see the benefits of health related behavior changes in terms of life expectancy by utilizing the longevity calculator. This tool is similar to the decision tool discussed above. The user's past and present health habits are set as they have been previously entered using the longevity calculator. However the personal lifestyle tool allows the user to modify those habits in the future. For example, if the user weighs 200 lbs., the user may enter 175 lbs. into the personal lifestyle tool user interface and see the effect this would have on the user's life expectancy as well as his or her retirement date. Some of the lifestyle choices may include diet, exercise, sleep, relationships, mental health, drug use, doctor visits, and risk taking. The user may make changes and view the effects on the user's longevity to help decide what habits are worth changing. Also, this tool may motivate the user as the user can see the expected death date as a visual point on a timeline.

In an embodiment, a financial lifestyle tool allows the user to see the benefits of changing their financial behavior in terms of the user's retirement date. This component is may be made up of seven parts; average years per vehicle, average age of vehicles when purchased, the price of the user's future shelter, annual pacifier expense, dollars per hour, hours per week, and future rental possibilities. This tool allows the user to override any of these six habits and see the effect of the change on the user's retirement date.

In an embodiment, the user inputs how much his or her future shelter will cost, when they will move, and how long they will be there to determine any additional costs or savings. A shelter is broken down into two types of expenses, the initial moving/transaction expenses and the annual expenses. Annual shelter expenses include property tax, maintenance, and utilities. All of these expenses are projected by taking a percent of the value of the shelter. Each percent may be controlled by the system administrator. For example, annual property tax is usually between 1% and 1.5% of the value of the shelter. Moving/transaction expenses include sales commission, transfer tax/title search, furnishing, moving expense, and time expense. The first four categories follow a percent of the value of the home as annual expenses. As for the time value, it may take approximately 320 hours (the 320 hours is an assumption that may be changed by a system administrator) to find, purchase, move and settle into a new home. Those hours are multiplied by the user's dollars per hour to determine the opportunity cost of the move. The total moving/transfer expenses are summed and divided by the number of year between now and the time the user expects to move out of the new home to find the moving/transfer expense per year. This yearly expense is added to the annual expenses of the new home and the total is subtracted from the current annual expenses of the user's existing home. The net present value of the projected annual savings or additional expense year over year is calculated and added to the user's investments.

In an embodiment, the system allows the user to enter detailed information regarding future rental possibilities. The information may include the purchase year, purchase price, down payment, monthly payment net cash flow and expected pay off year. The net cash flow is adjusted for inflation and adds to the user's retirement income year over year. If the net cash flow for the rental is negative, the negative amount is added to the user's retirement income. When the mortgage is paid off, the annual mortgage payment also adds to the user's retirement income year over year. With these additional sources of income, the user's retirement date can come earlier. However, the user must decide whether an earlier retirement is worth the additional time and energy needed to own a rental property.

In an embodiment, a timeline is presented to the user. Any information received by an individual on the user interface may be output on the timeline. A basic timeline has every year of a person's life (past, present and future) running horizontally or vertically across the page. The user may drill down into each year to show the date, the user's age, the spouse's age, the dependents'/kids' ages, where you lived, where you worked, etc. The system may show the costs of future decisions, social security/Medicare annual and cumulative earnings, pension incomes (both actual and possible), vehicles (owned/leased), shelters (owned/rented), employers in the past, present and future, current investment values and future projections, annual liability expenses, life insurance coverage, lump sums/inheritances, future personal and financial goals (as pictures or phrases), allocation of time, allocation of cash, expected longevity, future personal and financial recommendations, and net worth (past present and future). The timeline is capable of containing any information one would like and may be broken down monthly, weekly or daily rather than yearly. In this manner, the users visualize their lives as they have come from, where they are now and where they would like to go.

FIGS. 16-20 illustrate user interfaces that may be presented to the user using the outputs discussed above, according to various example embodiments. As stated above, these embodiments are intended to demonstrate the present subject matter and not in an exclusive or exhaustive sense. Changes are possible without departing from the scope of the present subject matter.

FIG. 16 is a coaching report user report according to an example embodiment. Displayed is an example user's optimal age to take social security and pension income is displayed. Other information that may be displayed is an insurance amount is calculated and displayed if needed. The insurance amount may be the amount a user would need today if their spouse were to die at age 62. Next, a recommendation on the burn ratio of non-qualified to qualified investments is displayed to minimize the user's tax liability. Other information that may be presented are investment projections including when the user will run out of money, the expected investment value at longevity, and estimated net worth at the user's death. FIG. 16 also displays example health habits and financial lifestyle changes that user may make. The health changes are accompanied by the years that could be saved by making the change. The financial lifestyle changes are accompanied by the impact the change would have on the user's retirement date.

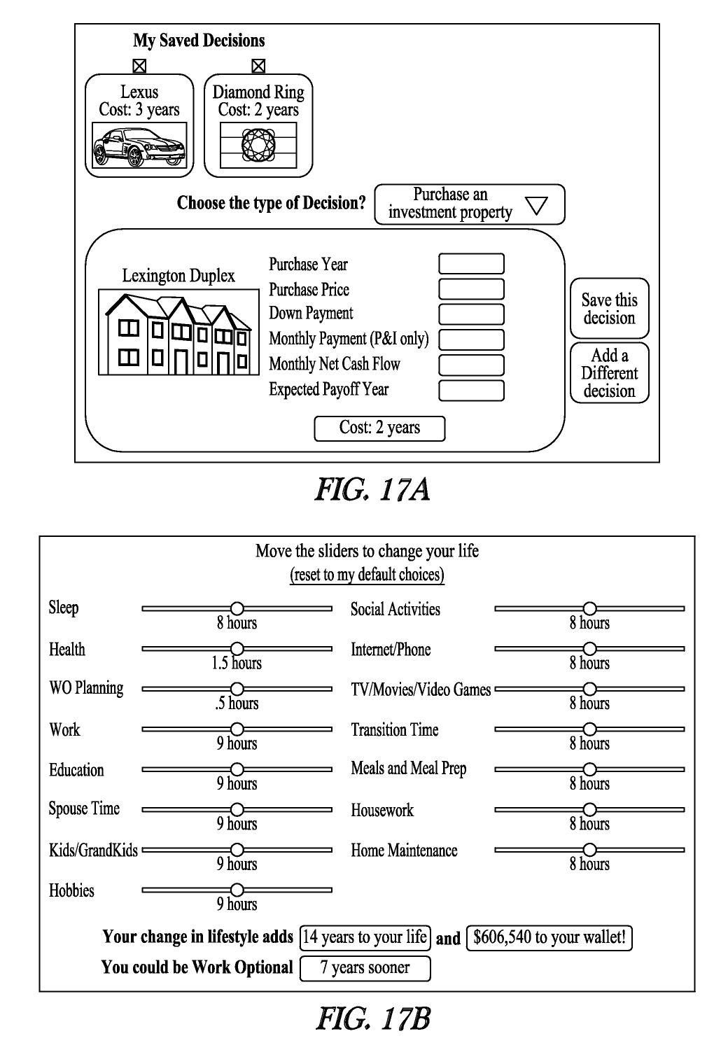

FIGS. 17A-17B illustrates example user interfaces where the user is able to input future decisions and habits, according to various embodiments. The goals may be represented visually or textually. Each decision has corresponding inputs that the user may fill in to complete the decision. For example, FIG. 17A illustrates a decision to purchase an investment property. These inputs flow to the retirement calculator where the costs are subtracted from the end user's investments. The user can see the consequences that each vision has on their retirement. In this manner, the user is equipped to make informed decisions.

FIG. 17B is a slider user interface for inputting future habitual changes according to an example embodiment. The habits may include future health habits, vehicle habits, shelter habits, pacifier habits, work habits, and rental habits. Future health habit inputs are connected to the longevity calculator. By changing the slider the user may see the effect the decision will have on the user's life expectancy, money, and retirement date.

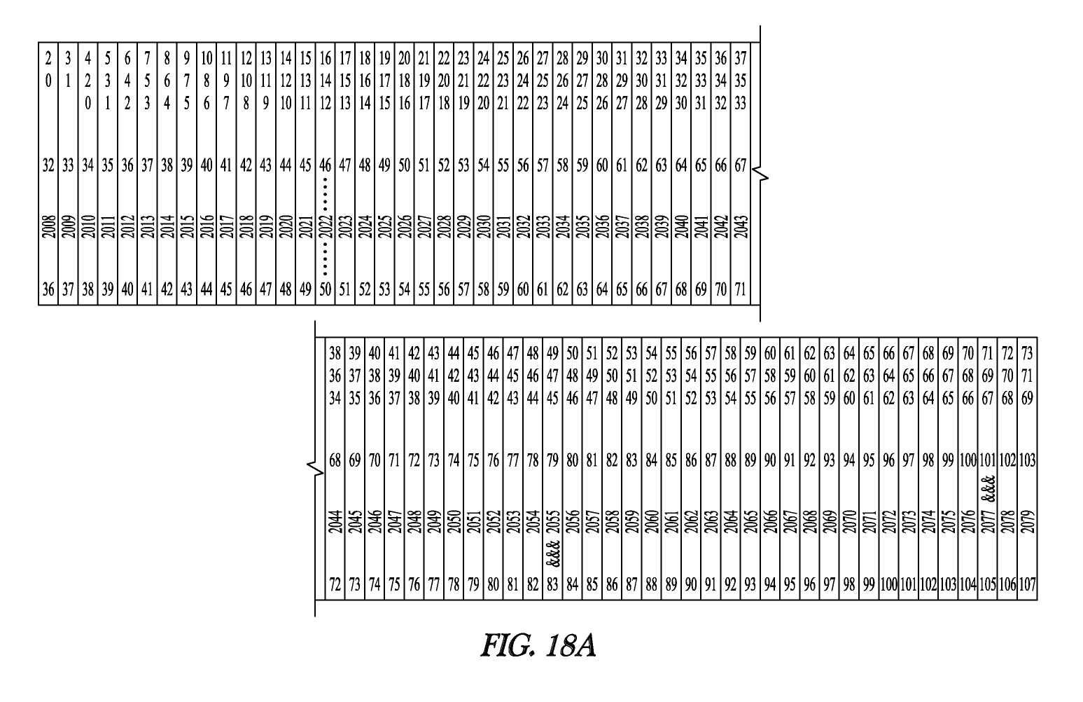

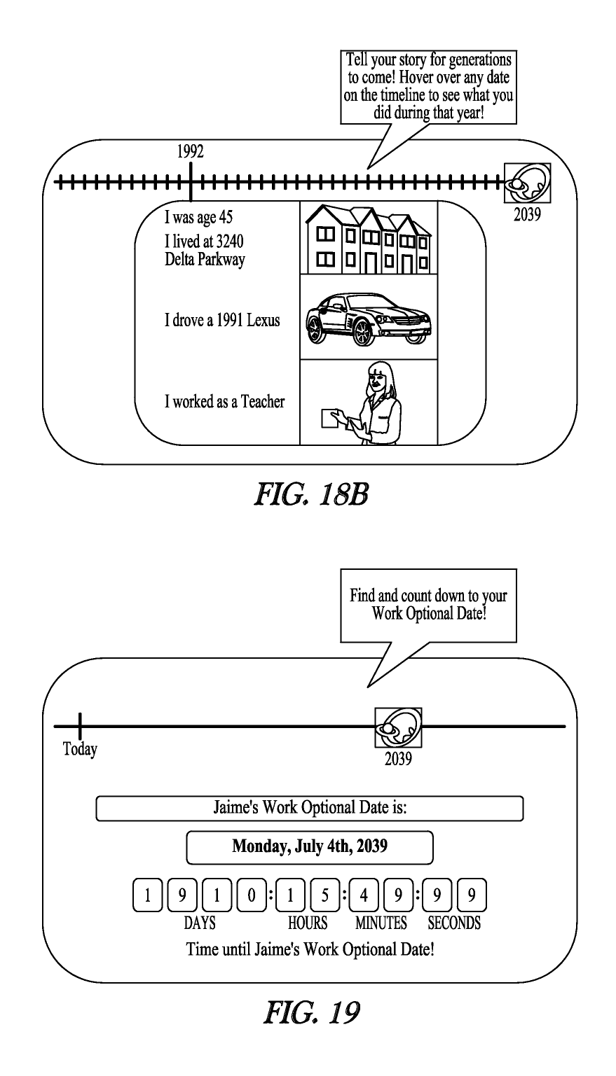

FIGS. 18A-18B illustrate user interfaces to visualize and interact with the user's timeline according to various embodiments. FIG. 18A displays an example timeline with the primary user's age running on the bottom. Above the user's age is the corresponding calendar year. Above the year is the spouse's age. Above the spouse's age are the kids'/dependences' ages. Also, different colored cells may represent working years versus retirement years. The &&&&& symbol represents the expected death of the user and the spouse estimated with the longevity calculator. Other symbols, colors, or visual indicators may be used to represent retirement, working, and deaths. FIG. 18B is an interactive timeline that allows a user to select a year and see where the user was at that point in the user's life. For example, FIG. 18B illustrates that in 1992 the user was 45 and worked as a teacher.

FIG. 19 is a user interface that displays the retirement calculator's output date, according to an example embodiment. In this case, the user's name is Jaime and her retirement date or work optional date is Monday, Jul. 4, 2039 and there are 1910 days to go.

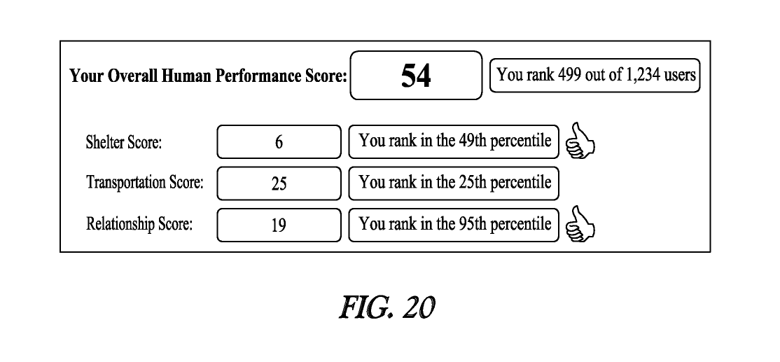

FIG. 20 is a user interface that displays an output associated with a ranking of the user, according to an example embodiment. In order to motivate the user to not only input his or her information but to continue to use the system periodically as a decision tool, a gaming aspect may be incorporated into the system. The gaming aspect contains multiple components. First, the user is ranked in a variety of categories. The rankings are based on US averages, world averages and other users (other geographic granularities may also be used). Categories may include, transition time, savings ratio, work optional age, pacifier spending and a variety of others.

In an embodiment, selected ranking will be continually posted while other rankings will be on a leader board of the month, for example. Those rankings might include but are not limited to, oldest vehicle, longest time working at the same company and who paid the most tax.

In an embodiment, the second component is a scoring system where users are given scores for various behaviors and decisions. These scores can correspond to years/months lost or gained by such behavior or they might be a simple _ out of 10. For example, the user will get a vehicle score which is based on the age of vehicles at purchase and how long they keep them before buying the next one. If they buy vehicle 7 years old and keep them for 7 years like we recommend, they might get a score of 9 out of 10 or they might get a score of 3 years. The 3 years could mean that because of their vehicle habits they are able to retire 3 years earlier than they would have if they had continued to follow US averages.

In an embodiment, a third component of the gaming aspect is called ‘fun facts.’ Here the user may experience a few popups as they input information to mitigate any connection to filling out taxes or the FAFSA. For example, on the first page, the user enters their date of birth and their dependents names and dates of birth. A fun fact may then pop up informing them of the average cost to raise a child in US. Scores, rankings and fun facts may appear throughout the user experience including both the inputs and the outputs of the system. In an embodiment, the user has the option to turn off the fun facts.

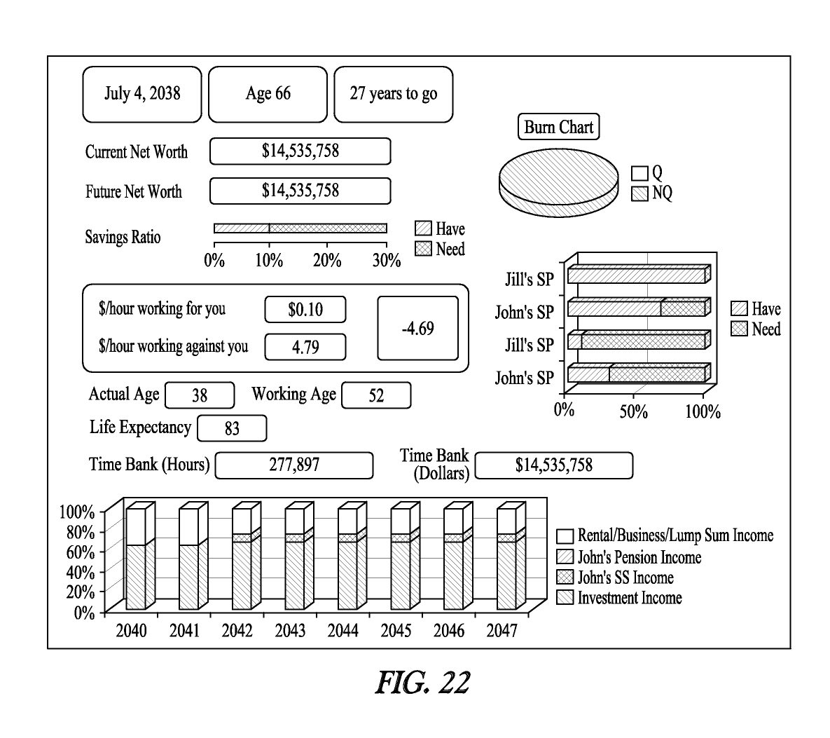

FIG. 22 is an output page, according to an example embodiment. The output page includes many of the components already discussed. However, the diagram further includes a time bank and a money working for you and against you section.

In an embodiment, the time bank gives the user an output in hours and an output in dollars. With respect to the hours, the system uses the user's longevity, hours, and subtracts the time the user spends asleep. Next, hours are converted into dollars. To make this conversion, the user's annual salary/income is taken and divided by the total hours in a year less the time the user spends sleeping. Once the dollars per hours is calculated, that number is multiplied by the hours the user has left to find the dollar value of the time bank. The user may use the time bank to see how a decision will affect the user's life.

In an embodiment, the amount of money working for the user is calculated. First, the number of hours in a year less the time the user spends sleeping is determined. Then one percent of the user's total investments is divided by the number of hours determined above. In an embodiment, the reason one percent is used is to be conservative and because average individual investors often obtain a long term return of only one or two percent. In various embodiments, other percentages may be used. With respect to the money working against the user, the total annual interest (for debt service) is divided it by the users' annual hours (less sleep) as discussed above.

In an embodiment, the system also incorporates an allocation module which outputs to the user how the user should allocate the user's investment accounts based on the user's inputs. This allows for a custom allocation for each user. This function may be used to gather assets and manage money for users or it may be outsourced to an outside firm. In general, the system outputs what percent of a user's investments should be allocated to stocks, bonds, gold, REITs, and fixed assets.

Specifically, in an embodiment, the system outputs for each market segment the specific funds that are to be purchased. For example, Bills allocation states he should have 30% (or $30,000 of his $100,000 investment value) to stocks. The system would choose from a specific list of funds that have been chosen by a system administrator and output that Bill should buy $15,000 of XYZ fund and $15,000 of ABC fund, for example. The user might get the overall general allocation as part of the subscription fee. However, if the user would like to specifically know the allocation, the user may purchase the money management portion of the system (which could be outsourced). Upon that purchase, the user receives the appropriate paperwork either via mail or on his computer. He then completes and sign either, on hard copy or using electronic signature, and returns it to the appropriate person (e.g., via mail, or secure electronic delivery). The user's investment accounts may be transferred and traded into the appropriate allocation automatically. The user may be able to rebalance periodically with automated guidelines from the system. Based on current allocations, the system may also provide various recommendations to user, such as “sell $10,000 of ABC fund”.

An example allocation method is as follows. First, the price to earnings ratio of the S&P 500 (this may be updated periodically by a system administrator) is used to determine the stock portion of the portfolio. If the P/E ratio is below the historical average of 15, the stocks are considered to be cheap and therefore a good buy. In general then, at a low P/E ratio stocks are over 50% of the portfolio, while at a high S&P 500 P/E ratio stocks are will be closer to 30% of the portfolio. In an embodiment, the boundaries for stock allocation are 20% to 80%, which means that no matter the economic environment, at least 20% of the portfolio is in stocks but no more the 80%.

In an embodiment, for bond allocations, the system uses the current 10 year treasury rate (this may be updated periodically by a system administrator or automatically). When treasury rates are low, the bond allocation is low (e.g., 30%). The reason being rising interest rates cause bond values to drop. Alternatively, when treasury rates are high the system may indicated to buy bonds and increase the allocation to lock in high rates. When interest rates fall the bond values will increase. In an embodiment, the boundaries for bond allocation are also 20% to 80%.

In an embodiment, to determine gold allocation, the system calculates the price of gold adjusted for inflation (this may be updated periodically by a system administrator or automatically). Since the 1970's gold has averaged about $500 an ounce (in year 2000 dollars). Thus, the system increases the gold allocation when gold prices are low and take profits (lessen the gold position) as gold prices increase. In an embodiment, the gold boundary is 2% to 20%.

In an embodiment, Real Estimate Investment Trusts (REITs) are treated similar to stocks but the system uses the Vanguard REIT Index (ETF) P/E ratio (this may be updated periodically by a system administrator or automatically) rather than the S&P 500 P/E ratio. When the P/E ratio is low the system considers REITs to be at a good price and increases the allocation. As the P/E ratio increases the system decreases the allocation. In an embodiment, the boundary for REITS is 3% to 20%.

In an embodiment, the remaining portion of the portfolio is invested in fixed assets; specifically, short term bonds, bond indexes, CD indexes, and money market accounts (this may be updated periodically by a system administrator or automatically). In an embodiment, the goal is to get a guaranteed 5% or 6% return to reduce the volatility of the portfolio. In various embodiments, the system does not try to outperform the S&P 500 but instead tries to outperform CDs. In an embodiment, the portfolios are designed to limit the downside risk to no more than ˜15%.

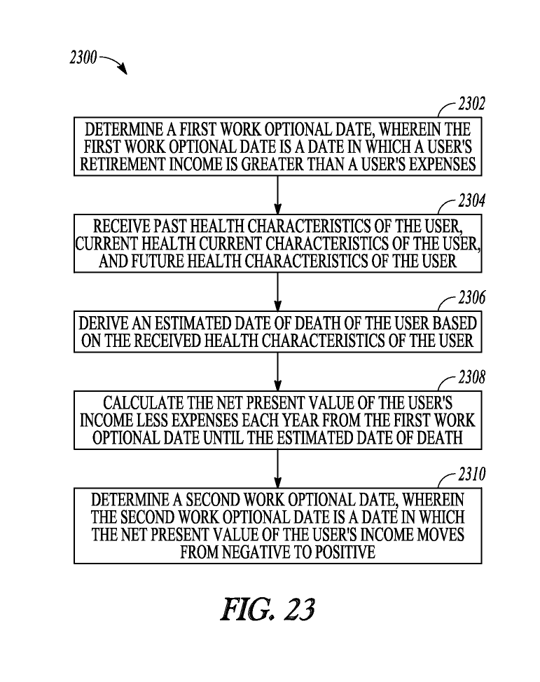

FIG. 23 is a flow chart illustrating a method 2300, in accordance with an example embodiment, using a combination of the tools and interfaces discussed above. The method 2300 may be performed by any of the modules, logic, or components described herein.

At block 2302, in an embodiment, a first work optional date is determined, wherein the first work optional date is a date in which a user's retirement income is greater than a user's expenses. The retirement income and expenses may be calculated based on input received from a user terminal.

At block 2304, in an embodiment, a system receives past health characteristics of the user, current health current characteristics of the user, and future health characteristics of the user. Past health characteristics may be based on data three years or prior, current health characteristics may be the past three years, and future characteristics may be aspiration goals. The characteristics may be entered using an input control (e.g., a slider, input box). For example, the user may enter in the frequency that the user has exercised in the past, is currently exercising, and hopes to exercise in the future.

At block 2306, in an embodiment, an estimated date of death of the user based on the received health characteristics of the user is derived. For example, based on the age of the user, an expected date of death may be retrieved from social security longevity tables. A life expectancy adjustment may be calculated based on the received health characteristics (e.g., plus five years). The life expectancy adjustment may be applied to the expected date of death. In various embodiments, life expectancy adjustments may be calculated separately for the received past, current, and future health characteristics.

At block 2308, in an embodiment, the net present value of the user's income less expenses each year from the first work optional date until the estimated date of death is calculated.

At block 2310, in an embodiment, a second work optional date, wherein the second work optional date is a date in which the net present value of the user's income moves from negative to positive, is determined.

In an embodiment, the first work optional date and the second work optional date are compared and, based on the comparison, a potential retirement date of the user may be determined. In an embodiment, the potential retirement date is the later of the two calculated work optional dates. In an embodiment, the received health characteristics may be updated and the potential retirement date may be updated.

In various embodiments, a coaching report with a suggested life change may be transmitted to a user terminal. The user terminal may be the same as the terminal which the user uses to enter in his or her health characteristics. The impact the suggested life change may have on the potential retirement date may be calculated and transmitted to the user terminal for presentation to the user.

Although various embodiments has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
determining, using at least one processor, a first work optional date, wherein the first work optional date is a date in which a user's retirement income is greater than a user's expenses;
receiving, using the at least one processor, past health characteristics of the user, current health current characteristics of the user, and future health characteristics of the user;
deriving, using the at least one processor, an estimated date of death of the user based on the received health characteristics of the user;
calculating, using the at least one processor, the net present value of the user's income less expenses each year from the first work optional date until the estimated date of death; and
determining, using the at least one processor, a second work optional date, wherein the second work optional date is a date in which the net present value of the user's income moves from negative to positive.

2. The method of claim 1, further comprising:
retrieving an expected date of death of the user based on a current age of the user; and
wherein deriving the estimated date of death comprises:
calculating a life expectancy adjustment based on the received health characteristics and the age of the user; and
applying the life expectancy adjustment to the expected date of death of the user.

3. The method of claim 2, wherein calculating a life expectancy adjustment based on the received health characteristics and the age of the user comprises:
calculating a first adjustment based on the received past health characteristics of the user;
calculating a second adjustment based on the received current health characteristics of the user; and
calculating a third adjustment based on the received future health characteristics of the user.

4. The method of claim 1, further comprising:
comparing the first work optional date and the second work optional date; and
determining a potential retirement date of the user based on the comparison.

5. The method of claim 4, further comprising:
receiving updated health characteristics of the user; and
updating the potential retirement date of the user based on the updated health characteristics of the user.

6. The method of claim 4, further comprising:
transmitting data representing a coaching report with a suggested life change to a user terminal; and
calculating the impact of the suggested life change on the potential retirement date of the user.

7. The method of claim 1, wherein the health characteristics is an exercise frequency.

8. A system comprising:
at least one processor; and
a storage medium with instructions stored thereon, which when executed by the at least one processor cause the at least one processor to:
determine a first work optional date, wherein the first work optional date is a date in which a user's retirement income is greater than a user's expenses;
receive past health characteristics of the user, current health current characteristics of the user, and future health characteristics of the user;
derive an estimated date of death of the user based on the received health characteristics of the user;
calculate the net present value of the user's income less expenses each year from the first work optional date until the estimated date of death; and
determine a second work optional date, wherein the second work optional date is a date in which the net present value of the user's income moves from negative to positive.

9. The system of claim 8, further comprising instructions to:
retrieve an expected date of death of the user based on a current age of the user; and
wherein deriving the estimated date of death comprises:
calculating a life expectancy adjustment based on the received health characteristics and the age of the user; and
applying the life expectancy adjustment to the expected date of death of the user.

10. The system of claim 9, wherein calculating a life expectancy adjustment based on the received health characteristics and the age of the user comprises:
calculating a first adjustment based on the received past health characteristics of the user;
calculating a second adjustment based on the received current health characteristics of the user; and
calculating a third adjustment based on the received future health characteristics of the user.

11. The system of claim 8, further comprising instructions to:
compare the first work optional date and the second work optional date; and
determine a potential retirement date of the user based on the comparison.

12. The system of claim 11, further comprising instructions to:
receive updated health characteristics of the user; and
update the potential retirement date of the user based on the updated health characteristics of the user.

13. The system of claim 11, further comprising instructions to:
transmit data representing a coaching report with a suggested life change to a user terminal; and
calculate the impact of the suggested life change on the potential retirement date of the user.

14. The system of claim 8, wherein the health characteristics is an exercise frequency.

15. A machine-readable storage device comprising instructions, which when executed by at least one processor, cause the at least one processor to:
determine a first work optional date, wherein the first work optional date is a date in which a user's retirement income is greater than a user's expenses;
receive past health characteristics of the user, current health current characteristics of the user, and future health characteristics of the user;
derive an estimated date of death of the user based on the received health characteristics of the user;
calculate the net present value of the user's income less expenses each year from the first work optional date until the estimated date of death; and
determine a second work optional date, wherein the second work optional date is a date in which the net present value of the user's income moves from negative to positive.

16. The storage device of claim 15, further comprising instructions to:
retrieve an expected date of death of the user based on a current age of the user; and
wherein deriving the estimated date of death comprises:
calculating a life expectancy adjustment based on the received health characteristics and the age of the user; and
applying the life expectancy adjustment to the expected date of death of the user.

17. The storage device of claim 16, wherein calculating a life expectancy adjustment based on the received health characteristics and the age of the user comprises:
calculating a first adjustment based on the received past health characteristics of the user;
calculating a second adjustment based on the received current health characteristics of the user; and
calculating a third adjustment based on the received future health characteristics of the user.

18. The storage device of claim 15, further comprising instructions to:
compare the first work optional date and the second work optional date; and
determine a potential retirement date of the user based on the comparison.

19. The storage device of claim 18, further comprising instructions to:
receive updated health characteristics of the user; and
update the potential retirement date of the user based on the updated health characteristics of the user.

20. The storage device of claim 18, further comprising instructions to:
transmit data representing a coaching report with a suggested life change to a user terminal; and
calculate the impact of the suggested life change on the potential retirement date of the user.
